(19) United States
(12) Patent Application Publication
(10) Pub. No.: US 2007/0209761 A1
(43) Pub. Date: Sep. 13, 2007

(54) STRETCH LABEL AFFIXING JIG

(76) Inventors: Teruo Hitosugi, Sunto-gun (JP); Hideo Ichikawa, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/684,845

(22) Filed: Mar. 12, 2007

(30) Foreign Application Priority Data
Mar. 13, 2006 (JP) 2006-066859

(51) Int. Cl. B29C 63/04; B32B 37/00

(52) U.S. Cl. 156/475; 156/494

(57) ABSTRACT

The present invention aims to provide a label affixing jig which has an A member formed so as to allow a container to pass therethrough, a B member formed so as to allow the container to pass therethrough, a C member, and a D member, wherein the A member is configured to follow expansion and contraction of the B member to closely contact with the adhesive surface of a cylindrically curled stretch label and hold the stretch label on the A member; the B member is configured to contract and expand the A member in the radial direction of the cylindrically curled stretch label; and the C member is a holder of the container; and the D member is a pedestal for the C member and is equipped with a height adjustment unit configured to adjust the height of the C member.

### BACKGROUND OF THE INVENTION

1. Field of the Invention

The present invention relates to a method for producing a jig used to affix a label to the outer surface of a powder container filled with a powder such as toner, chemical products, cosmetics, and food.

2. Description of the Related Art

Conventionally, to a toner container which is one example of powder containers, a label has been affixed to the toner container utilizing heat shrinkage. The affixing of a label allows for easily identifying which color toner, for example, cyan toner, magenta toner, yellow toner, and black toner is set inside of a toner container even from the outside.

Since such a label had been affixed to a toner container before the toner container was filled with a toner, there was no need to take into consideration that the heat affects on the toner itself.

However, in recent years, there may be a case where there is a need to affix a label to the outer surface of a toner container in a state where the toner container is filled with a toner. In such a case, it is unfavorable to employ the heat shrinkage method because the toner itself is thermally affected and then degraded in quality, and large equipment used for application of heat is required, resulting in an increased amount of carbon dioxide which adversely affects global warming. For this reason, a stretch label capable of being affixed by only elastic force of the label is now widely used without the necessity of heat. The tendency is not limited to toner containers, and the same applies to other powder containers.

However, in order to affix a label to the outer surface of a container by only elastic force of the label, it is necessary to manually affix the label using an affixing jig or to affix the label using a machine. To this end, a label should be attached to a jig, however, when a label is attached to a jig, the following problems are caused. Such a label cannot be necessarily attached to the outer surface of the jig in an easy manner, resulting in inefficiency in label attachment. When a label that is similar in length to a container is attached to the surface of a container, there are variations in label attachment positions, resulting in further need of readjusting the position to which the label is to be attached.

For example, Japanese Patent Application Laid-Open (JP-A) No. 2004-91051 discloses a label affixing jig that allows for easy attachment of a stretch label on a predetermined position, and in the label affixing jig, the label attachment part of the jig is formed in a tapered shape and is slit up, thereby allowing for easy attachment. With the label affixing jig, however, there is a need to put the jig on a desk once and then attach a label with both hands, and it involves an immense amount of time and effort to attach labels.

In addition, when a label that is similar in length to a container is attached to the jig, it is necessary to lift the container and move the label to a predetermined attachment position to check the attachment position before pulling the jig out from the label. Therefore, there are problems with inefficiency in attachment of labels, varied attachment positions of labels, and readjustments of position of label.

### BRIEF SUMMARY OF THE INVENTION

The present invention aims to provide a stretch label affixing jig which is capable of precisely affixing a stretch label to a predetermined position of the label affixing jig in an easy manner and allows for increasing efficiency in attachment of labels without the necessity of readjustment of label attachment position.

The means to solve the above-noted problems are as follows.

<1> A label affixing jig which has an A member formed so as to allow a container to pass therethrough, a B member formed so as to allow the container to pass therethrough, a C member, and a D member, wherein the A member is configured to follow expansion and contraction of the B member to closely contact with the adhesive surface of a cylindrically curled stretch label and hold the stretch label on the A member; the B member is configured to contract and expand the A member in the radial direction of the cylindrically curled stretch label; and the C member is a holder of the container; and the D member is a pedestal for the C member and is equipped with a height adjustment unit configured to adjust the height of the C member.

<2> The label affixing jig according to the item <1>, wherein the outer circumferential surface of the B member is fixed to the inner circumferential surface of the A member, or the inner circumferential surface of the B member is fixed to the outer circumferential surface of the A member.

<3> The label affixing member according to the item <1>, wherein the A member and the B member are respectively formed in a cylindrical shape and can be contracted in the radial direction in a curled state where at least a part of both members are partially overlapped each other and can be expanded by restoring the B member to the original condition.

<4> The label affixing member according to the item <1>, further having a stretch label positioning guide of which at lest one site thereof is thicker than the stretch label, on the outer circumferential surface of the A member.

<5> The label affixing member according to the item <1>, wherein the C member has an external diameter smaller than the inner diameter of the container and is configured to pass through an adapter constituted by the A member and the B member.

<6> The label affixing member according to the item <1>, wherein the D member has an external diameter larger than the inner diameter of the adapter constituted by the A member and the B member.

<7> The label affixing member according to the item <1>, wherein the D member is heavier than at least the C member.

<8> The label affixing member according to the item <1>, wherein the B member can be expanded and contracted in the radial direction with a force of 1 kgf to 100 kgf.

<9> The label affixing member according to the item <1>, wherein the top end of the C member is formed in a concave or convex shape which is an inverted shape of the bottom shape of the container so as to stably fit each other.

<10> The label affixing member according to the item <1>, wherein the container is formed in a cylindrical column shape.

<11> The label affixing member according to the item <1>, wherein the stretch label is cylindrically curled.

<12> The label affixing member according to the item <1>, wherein the B member is shaped to flare outwardly at the lower end.

A stretch label affixing jig according to the present invention is capable of precisely attaching a stretch label to a predetermined position of the label affixing jig in an easy manner and allows for increasing efficiency in attachment of labels without the necessity of readjustment of label attachment position because a stretch label itself can be easily attached to the stretch label affixing jig.

### BRIEF DESCRIPTION OF THE SEVERAL VIEWS OF THE DRAWINGS

FIG. 1 is an illustration showing an example of the label affixing jig of the present invention.

FIG. 2 is an illustration exemplarily depicting the method of attaching a stretch label to a body of the label affixing jig of the present invention.

FIG. 3 is another illustration exemplarily depicting the method of attaching a stretch label to the body of the label affixing jig of the present invention.

FIG. 4 is still another illustration exemplarily depicting the method of attaching a stretch label to the body of the label affixing jig of the present invention.

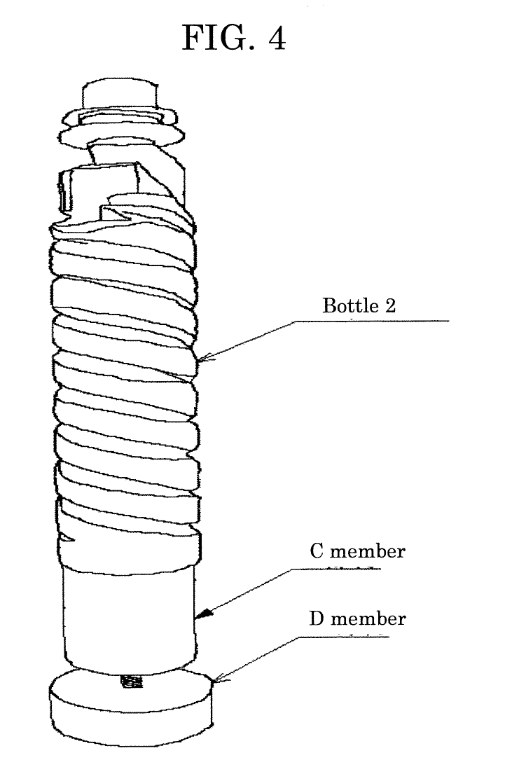

FIG. 5 is yet another illustration exemplarily depicting the method of attaching a stretch label to the body of the label affixing jig of the present invention.

FIG. 6 is still yet another illustration exemplarily depicting the method of attaching a stretch label to the body of the label affixing jig of the present invention.

FIG. 7 is still yet another illustration exemplarily depicting the method of attaching a stretch label to the body of the label affixing jig of the present invention.

FIG. 8 is still yet another illustration exemplarily depicting the method of attaching a stretch label to the body of the label affixing jig of the present invention.

### DETAILED DESCRIPTION OF THE INVENTION

Hereinafter, the present invention will be further described in detail.

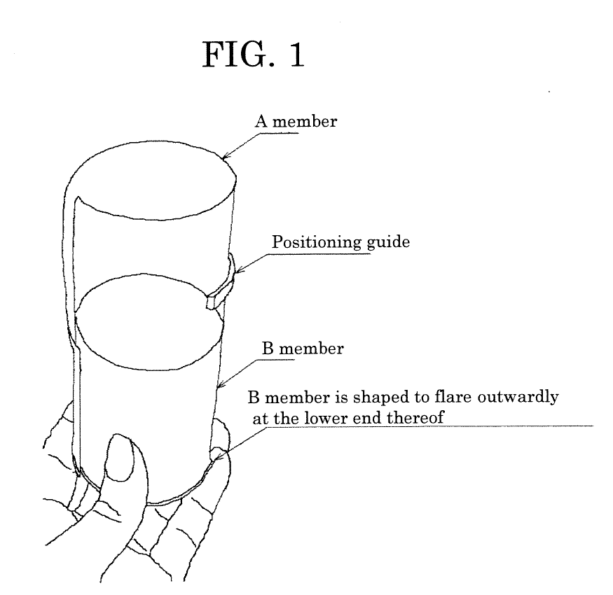

The label affixing jig of the present invention is composed of an A member having a function to hold a stretch label to closely contact with the adhesive surface of the stretch label; a B member which can be expanded and contracted in the radial direction thereof and having a function to hold the stretch label on the A member as shown in FIG. 1, a C member serving as a holder to hold a container, and a D member which is a pedestal having a function to adjust the height of the C member.

The A member is formed in a substantially cylindrical column shape, however, the A member is not fixed radially and is configured to follow expansion and contraction of the B member. The A member is provided with a positioning guide so as to immobilize a stretch label to a predetermined position of the A member. For the positioning guide, it is preferable to form the positioning guide thicker than a stretch label to be attached such that the stretch label cannot run on to the positioning guide itself. With this configuration, the stretch label can be easily attached to a stretch label affixing jig at an appropriate position.

The B member is formed in a substantially cylindrical column shape, however, when a force is applied to the B member radially, it is preferable, for example, that the B member is composed of an elastic material that can be contracted in a curled shape in the radial direction and can be expanded by restoring the B member to the original condition. Alternatively, the B member may be originally formed in a curled shape, however, the center portion of the B member is not provided with a curled part so as to allow a container to pass. In other words, the B member is only required that two circumferential ends thereof constituting the cylindrical column body relatively move in the counter direction by pressing force in the radial direction to thereby shorten the diameter of the B member, and the B member can be restored to the original condition by releasing the pressing force.

The B member is also configured such that the B member can be contracted in the radial direction with a force of 1 kgf to kgf, however, preferably, the B member can be easily contracted manually with grip strength, and to also maintain a certain hardness of the B member, the B member preferably has a degree of hardness that the B member can be contracted with a force of 10 kgf to 30 kgf. Basically, the B member has a degree of hardness that the B member can be vorticosely contracted. For material of the B member, stainless-steel is preferably used from the perspective of durability in terms of hardness retention, however, the material of the B member is not limited to stainless-steel as long as the material can be vorticosely contracted, and plastics and metals may be used.

To maintain the contraction and expansion properties or stretchability and hardness of the B member and to make it easy to insert a bottle into the B member, the B member may be shaped to flare outwardly at the lower end. It should be noted that the A member and the B member constitute an adapter.

The C member is formed in a cylindrical column shape and has a smaller external diameter than that of a container to which a stretch label is to be affixed. For this reason, the adapter constituted by the A member and the B member is movable to the bottom of the C member. With this configuration, a stretch label can be affixed to the lower portion of the container as well. For the distance to which the C member is movable, it is preferably that the adapter is movable to about half the total of the height of the A member combined with the height of the B member, however, the adapter may be movable to a position lower than the total height because the attachment position of the stretch label can be adjusted depending on the configuration with the D member. Further, the C member serves as a pedestal to hold a container, and to stably hold a container, and the top end of the C member is preferably formed in a shape which is an inverted shape of the bottom shape of the container.

The D member is formed in a cylindrical column shape, however, the shape of the D member is not limited thereto as long as the D member has an external diameter larger than the external diameter of a container to which a stretch label is to be affixed, and has a size so as not to make the adapter constituted by the A member and the B member pass therethrough. For the weight of the D member, the D member is heavier than at least the C member. With this configuration, a stretch label can be stably set when the stretch label is to be affixed to a container. Further, the D member has a screw or one alternative to the screw such as a pole brace such that the height position of the C member can be adjusted using the D member. As the result, it is possible to obtain an effect to easily change the label attachment position.

Among the members used in the stretch label affixing jig, the outer surface of the A member makes contact with a stretch label, and the A member moves in a state where the inner surface thereof makes contact with a container, and thus the A member is liable to be damaged or degraded. To avoid such a problem, the stretch label affixing jig can be broken down into pieces to readily exchange the A member alone for a new one.

In the present invention, it is more preferably that the A member is composed of a stretchable material. Use of a stretchable material for the A member allows for further preventing damage and degradation of the A member.

It is more preferably that the A member is composed of PET with “t” ranging 0 μm to 200 μm. With this configuration, it is possible to further prevent damage and degradation of the A member when a stretch label is attached thereto.

Further, the inner circumferential surface of the A member may be fixed to the outer circumferential surface of the B member with a two-sided adhesive tape or the outer circumferential surface of the A member may be fixed to the inner circumferential surface of the B member with a two-sided adhesive tape, however, the method of fixing the A member to the B member is not limited thereto. For example, a fixing agent such as adhesive bond may be used. Since a container is made to pass therethrough on the inner circumferential surface side, it is preferable to fix the outer circumferential surface of the A member to the inner circumferential surface of the B member because the container is hardly scratched and damaged.

Further, both the A member and the B member may be respectively formed in a curled shape and the ends of the both members in the height direction of the columnar bodies may be overlapped each other. In this case, the both ends of the A member and the B member may be fixed each other, however, when the A member is outwardly biased, the A member and the B member can be held stably without fixing the both members by placing the A member on the inner circumferential surface side. The A member and the B member may be formed in an integral unit.

The A member, B member, C member, and C member constituting the stretch label affixing jig of the present invention are prepared by using materials such as plastics and metals, and it is particularly preferable that the A member is prepared using plastic because plastics hardly scratch a container.

### EXAMPLES

Hereinafter, the method of attaching a stretch label to a stretch label affixing jig of the present invention will be described below.

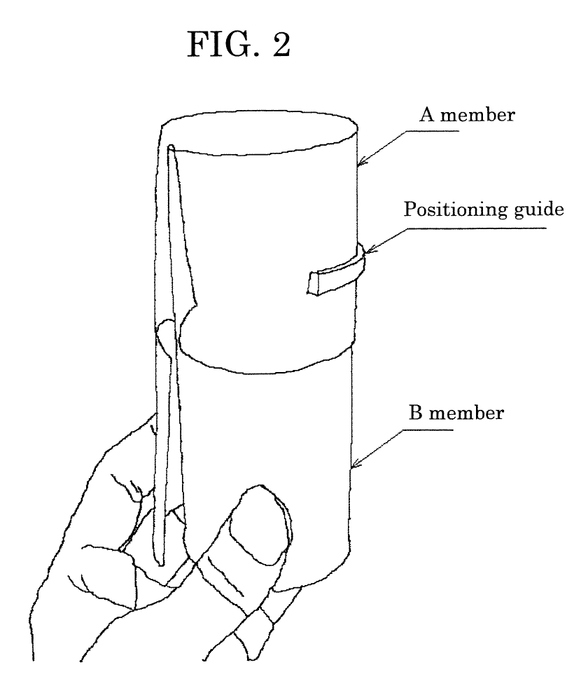

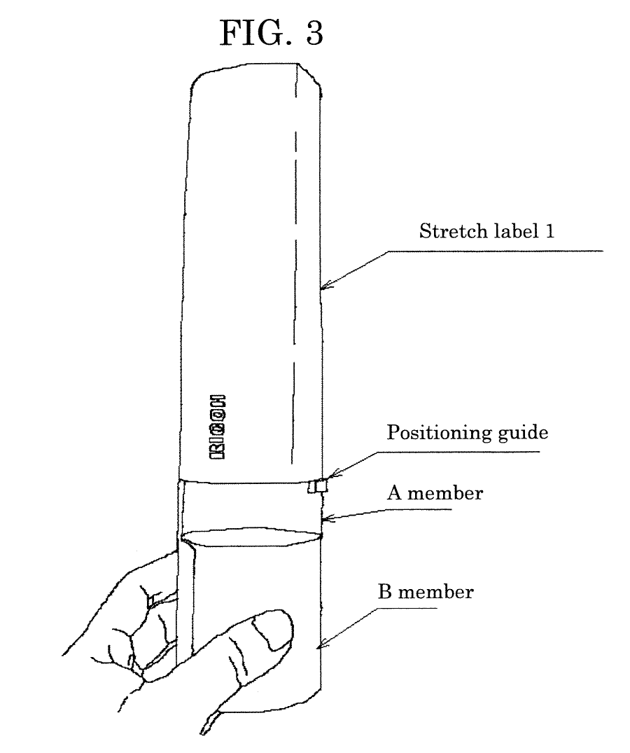

(1) First, as shown in FIG. 2, a body of a stretch label affixing jig which is constituted by an A member and a B member is grasped with one hand, and the stretch label affixing jig is contracted such that both ends thereof are formed in a curled shape. With another hand, a stretch label 1 is placed on the jig body constituted by the A member and the B member such that the A member disposed on the upper side of the jig is covered with the stretch label 1. Then, as shown in FIG. 3, the curled state in the jig body which is constituted by the A member and the B member is released to thereby fix the stretch label 1 to the stretch label affixing jig.

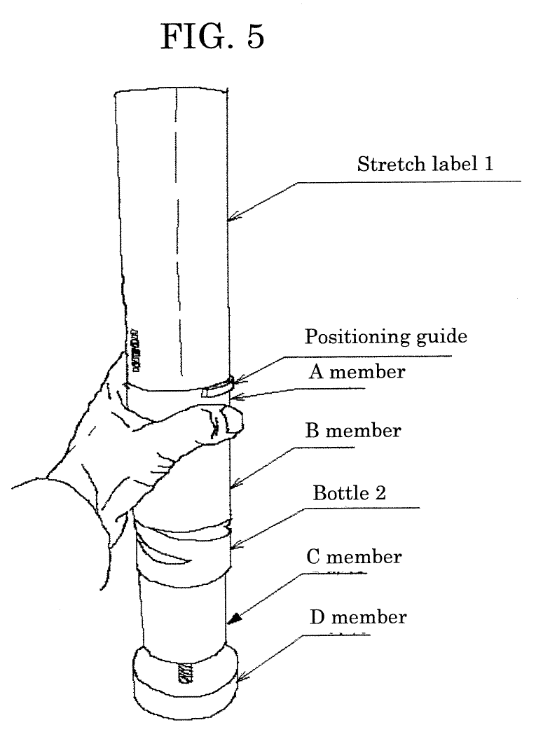

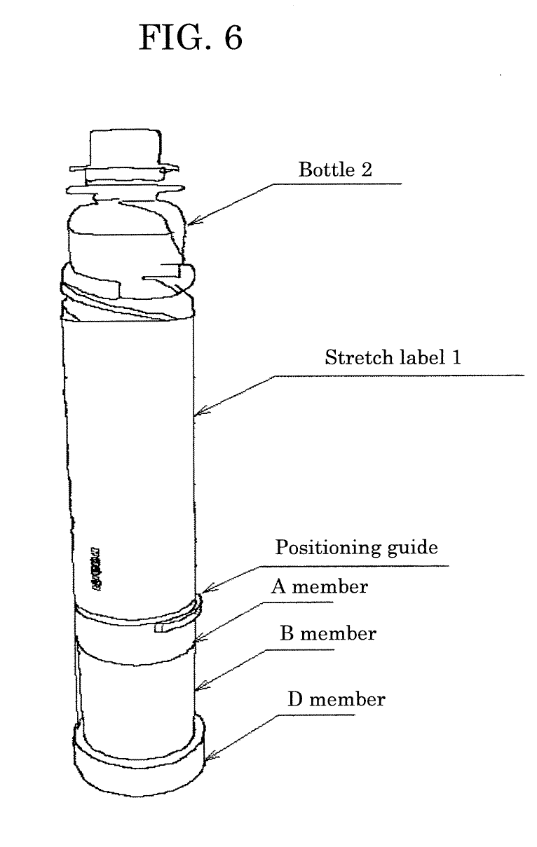

(2) Thereafter, as shown in FIG. 5, a bottle 2 set at a pedestal constituted by a C member and a D member is inserted to the jig body which is constituted by the A member and the B member while holding the stretch label 1 held on the jig body so as to be immobilized, and the bottle 2 is inserted in the jig body until the B member bumps against the D member, as shown in FIG. 6.

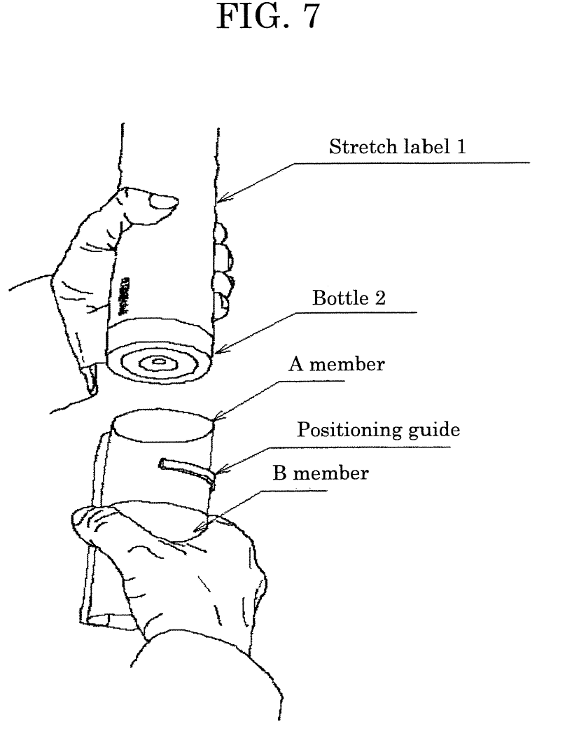

(3) Thereafter, as shown in FIG. 7, the jig body that is constituted by the A member and the B member and is covered with the stretch label 1 to the bottom of the bottle 2 is pulled out from the bottom of the bottle 2 while holing on the bottle 2 with one hand so as not to move the upper portion of the bottle 2.

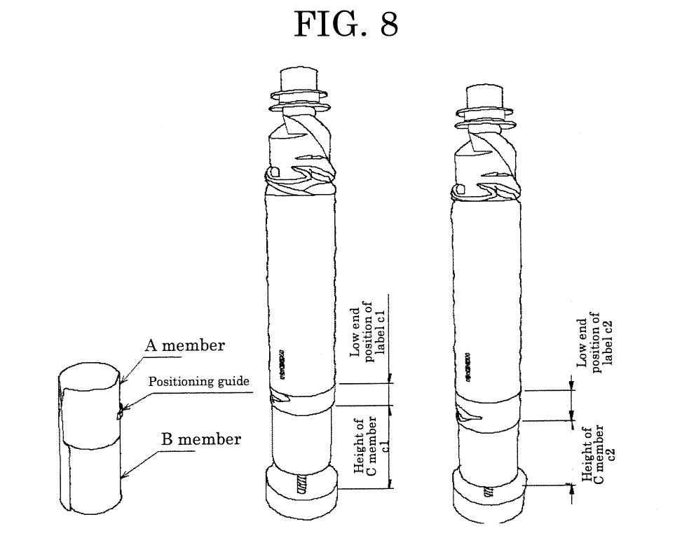

(4) As shown in FIG. 8, the attachment position of the stretch label 1 to the bottle 2 can be changed from “e1” to “e2” by changing the height of the C member in the bottle fixing pedestal which is constituted by the C member and the D member. Even when the position to which the label is affixed to a bottle is changed depending on the bottle type, the label attachment position is adjustable and changeable with ease.

It should be noted that the above-noted Example shows a case where a stretch label is attached to a bottle with hands, however, a stretch label affixing jig of the present invention, as a matter of course, can be incorporated into a machine to automate the above-noted process.

What is claimed is:

1. A label affixing jig, comprising:
an A member formed so as to allow a container to pass therethrough,
a B member formed so as to allow the container to pass therethrough,
a C member, and
a D member,
wherein the A member is configured to follow expansion and contraction of the B member to closely contact with the adhesive surface of a cylindrically curled stretch label and hold the stretch label on the A member; the B member is configured to contract and expand the A member in the radial direction of the cylindrically curled stretch label; and the C member is a holder of the container; and the D member is a pedestal for the C member and is equipped with a height adjustment unit configured to adjust the height of the C member.

2. The label affixing jig according to claim 1, wherein the outer circumferential surface of the B member is fixed to the inner circumferential surface of the A member, or the inner circumferential surface of the B member is fixed to the outer circumferential surface of the A member.

3. The label affixing member according to claim 1, wherein the A member and the B member are respectively formed in a cylindrical shape and can be contracted in the radial direction in a curled state where at least a part of both members are partially overlapped each other and can be expanded by restoring the B member to the original condition.

4. The label affixing member according to claim 1, further comprising a stretch label positioning guide of which at lest one site thereof is thicker than the stretch label, on the outer circumferential surface of the A member.

5. The label affixing member according to claim 1, wherein the C member has an external diameter smaller than the inner diameter of the container and is configured to pass through an adapter constituted by the A member and the B member.

6. The label affixing member according to claim 1, wherein the D member has an external diameter larger than the inner diameter of the adapter constituted by the A member and the B member.

7. The label affixing member according to claim 1, wherein the D member is heavier than at least the C member.

8. The label affixing member according to claim 1, wherein the B member can be expanded and contracted in the radial direction with a force of 1 kgf to 100 kgf.

9. The label affixing member according to claim 1, wherein the top end of the C member is formed in a concave or convex shape which is an inverted shape of the bottom shape of the container so as to stably fit each other.

10. The label affixing member according to claim 1, wherein the container is formed in a cylindrical column shape.

11. The label affixing member according to claim 1, wherein the stretch label is cylindrically curled.

12. The label affixing member according to claim 1, wherein the B member is shaped to flare outwardly at the lower end.
